(19) United States
(12) Patent Application Publication
(10) Pub. No.: US 2026/0280864 A1
(43) Pub. Date: Sep. 17, 2026

(54) Quantum-Resistant Wireless Communications

(71) Applicant: Cisco Technology, Inc., San Jose, CA (US)

(72) Inventors: Ashish KUNDU, Milpitas, CA (US); Ramana Rao V.R. KOMPELLA, Foster City, CA (US)

(73) Assignee: Cisco Technology, Inc., San Jose, CA (US)

(21) Appl. No.: 19/047,486

(22) Filed: Feb. 6, 2025

(51) Int. Cl. H04L 9/08; H04W 12/47

(52) U.S. Cl. CPC H04L 9/0861; H04L 9/085; H04W 12/47

(57) ABSTRACT

In one implementation, a key management service executed by a device determines cryptographic capabilities of a wireless client and an access point in a wireless network. The key management service selects a post-quantum cryptographic key generation approach for use by the wireless client and the access point based on their cryptographic capabilities. The key management service generates a key exchange policy for the wireless client and the access point that specifies one or more out-of-band paths that differ from a Wi-Fi link between the wireless client and the access point. The key management service causes the wireless client and the access point to perform a key exchange to associate the wireless client with the access point in the wireless network in part by generating keys using the post-quantum cryptographic key generation approach and exchanged via the one or more out-of-band paths specified by the key exchange policy.

### TECHNICAL FIELD

The present disclosure relates generally to wireless communications and, more particularly, to quantum-resistant wireless communications.

### BACKGROUND

Many of the cryptographic protocols in use today were not designed with quantum computing in mind, presenting new challenges for network security. Generally, quantum computing represents a significant shift in technology. Traditionally, computers have relied on bits that represent the binary states of their constituent transistors (i.e., a ‘1’ or a ‘0’). In contrast, quantum computers rely on quantum bits, which are referred to as “qubits,” which are two-state, quantum mechanical systems that can represent not only the traditional binary values of ‘1’ and ‘0,’ but also the superposition of the two, as well.

For instance, a quantum computer executing Shor's algorithm with enough qubits could be used to break commonly used public key cryptography protocols, such as Rivest-Shamir-Adelman (RSA), certain variations of Diffie-Hellman key exchange (e.g., elliptic curve, finite field, etc.), and the like. This creates a moving target for security experts, as the encryption protocols that network devices use to encrypt their traffic become increasingly vulnerable to advances in quantum computing.

Wireless communications, such as those within a Wi-Fi network, are particularly vulnerable to post-quantum threats, as they rely on a key exchange between an access point and a wireless client during their handshake operations. However, the encryption protocols in use today were not designed with quantum computing in mind.

### BRIEF DESCRIPTION OF THE DRAWINGS

The implementations herein may be better understood by referring to the following description in conjunction with the accompanying drawings in which like reference numerals indicate identically or functionally similar elements, of which:

FIGS. 1A-1B illustrate an example communication network;

FIG. 2 illustrates an example computing device/node;

FIG. 3 illustrates an example wireless network;

FIG. 4 illustrates an example architecture for quantum-resistant wireless communications; and

FIG. 5 illustrates an example simplified procedure for establishing quantum-resistant wireless communications, in accordance with one or more implementations described herein.

### DESCRIPTION OF EXAMPLE IMPLEMENTATIONS

### Overview

According to one or more implementations of the disclosure, a key management service executed by a device determines cryptographic capabilities of a wireless client and an access point in a wireless network. The key management service selects a post-quantum cryptographic key generation approach for use by the wireless client and the access point based on their cryptographic capabilities. The key management service generates a key exchange policy for the wireless client and the access point that specifies one or more out-of-band paths that differ from a Wi-Fi link between the wireless client and the access point. The key management service causes the wireless client and the access point to perform a key exchange to associate the wireless client with the access point in the wireless network in part by generating keys using the post-quantum cryptographic key generation approach and exchanged via the one or more out-of-band paths specified by the key exchange policy.

Other implementations are described below, and this overview is not meant to limit the scope of the present disclosure.

### DESCRIPTION

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

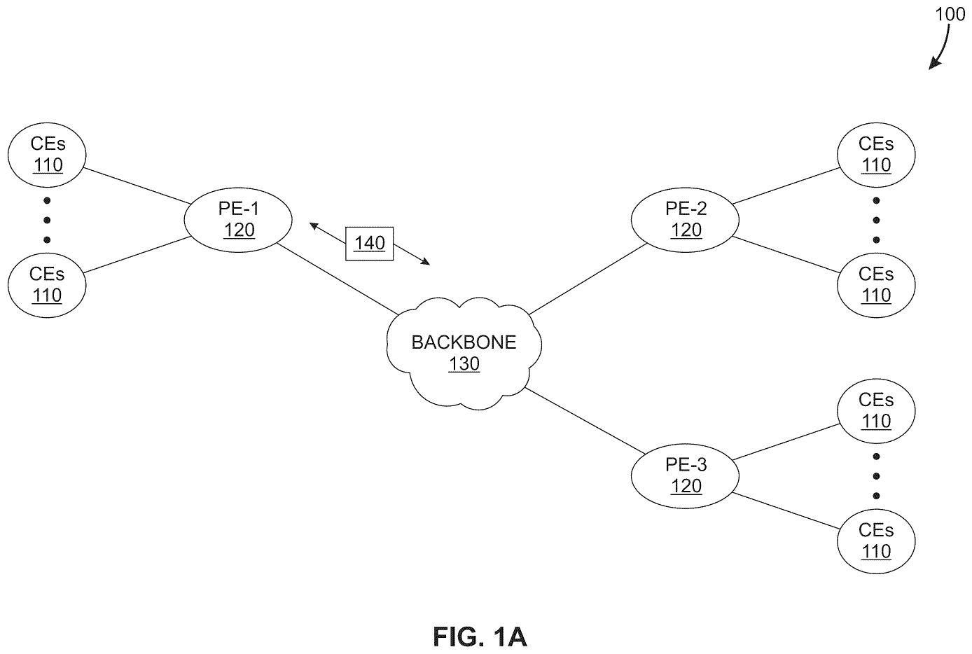

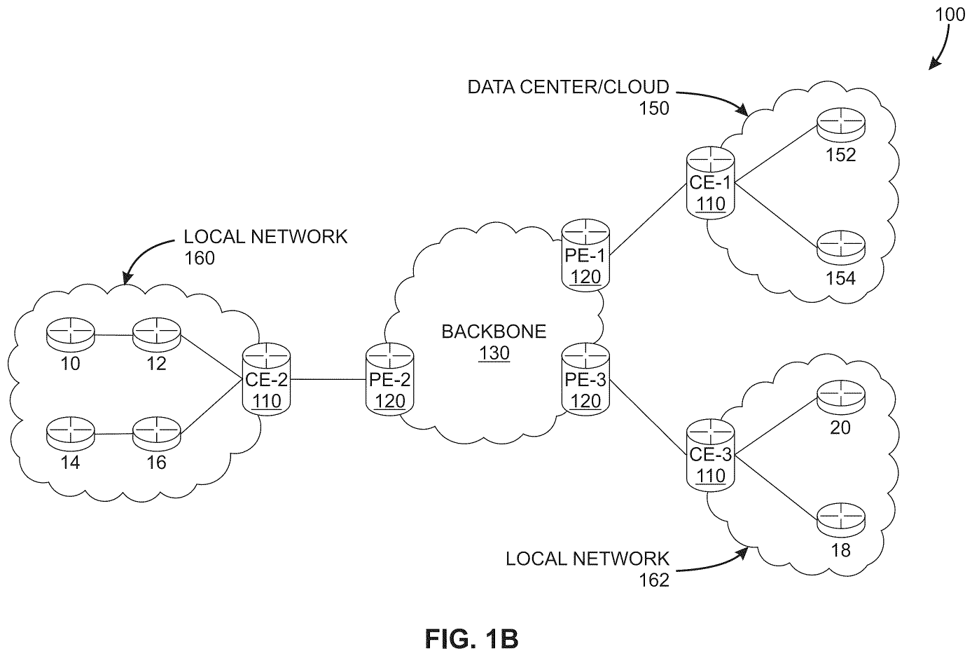

FIG. 1A is a schematic block diagram of an example network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:
1.) Site Type A: a site connected to the network (e.g., via a private or VPN link) using a single CE router and a single link, with potentially a backup link (e.g., a 3G/4G/5G/LTE backup connection). For example, a particular CE router 110 shown in network 100 may support a given customer site, potentially also with a backup link, such as a wireless connection.
2.) Site Type B: a site connected to the network by the CE router via two primary links (e.g., from different Service Providers), with potentially a backup link (e.g., a 3G/4G/5G/LTE connection). A site of type B may itself be of different types:
2a.) Site Type B1: a site connected to the network using two MPLS VPN links (e.g., from different Service Providers), with potentially a backup link (e.g., a 3G/4G/5G/LTE connection).
2b.) Site Type B2: a site connected to the network using one MPLS VPN link and one link connected to the public Internet, with potentially a backup link (e.g., a 3G/4G/5G/LTE connection). For example, a particular customer site may be connected to network 100 via PE-3 and via a separate Internet connection, potentially also with a wireless backup link.
2c.) Site Type B3: a site connected to the network using two links connected to the public Internet, with potentially a backup link (e.g., a 3G/4G/5G/LTE connection).

Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).
3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router 110 connected to PE-2 and a second CE router 110 connected to PE-3.

FIG. 1B illustrates an example of network 100 in greater detail, according to various implementations. As shown, network backbone 130 may provide connectivity between devices located in different geographical areas and/or different types of local networks. For example, network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various implementations, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some implementations, the techniques herein may be applied to other network topologies and configurations. For example, the techniques herein may be applied to peering points with high-speed links, data centers, etc.

According to various implementations, a software-defined WAN (SD-WAN) may be used in network 100 to connect local network 160, local network 162, and data center/cloud environment 150. In general, an SD-WAN uses a software defined networking (SDN)-based approach to instantiate tunnels on top of the physical network and control routing decisions, accordingly. For example, as noted above, one tunnel may connect router CE-2 at the edge of local network 160 to router CE-1 at the edge of data center/cloud environment 150 over an MPLS or Internet-based service provider network in backbone 130. Similarly, a second tunnel may also connect these routers over a 4G/5G/LTE cellular service provider network. SD-WAN techniques allow the WAN functions to be virtualized, essentially forming a virtual connection between local network 160 and data center/cloud environment 150 on top of the various underlying connections. Another feature of SD-WAN is centralized management by a supervisory service that can monitor and adjust the various connections, as needed.

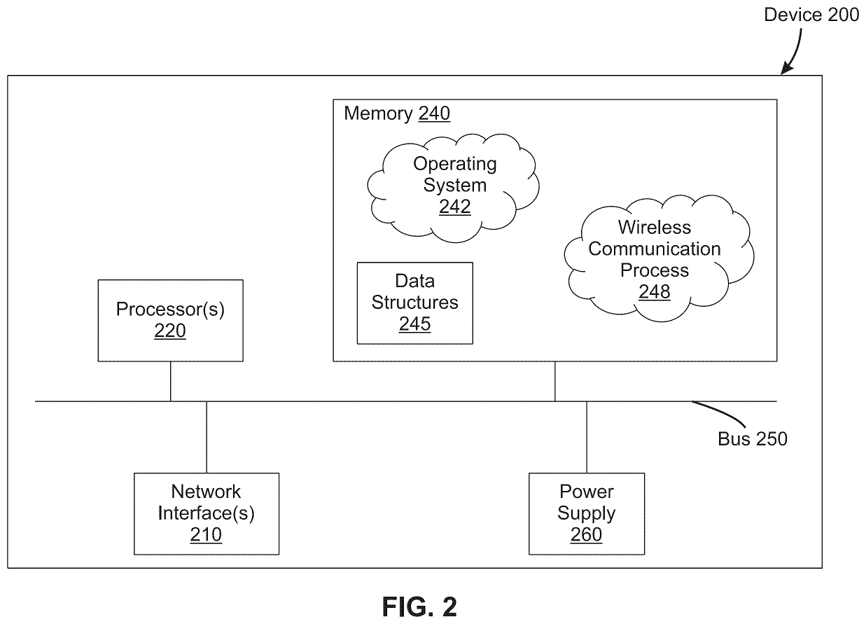

FIG. 2 is a schematic block diagram of an example node/device 200 (e.g., an apparatus) that may be used with one or more implementations described herein, e.g., as any of the devices shown in FIGS. 1A-1B above. Device 200 may comprise one or more network interfaces, such as interfaces 210 (e.g., wired, wireless, network interfaces, etc.), at least one processor (e.g., processor 220), and a memory 240 interconnected by a system bus 250, as well as a power supply 260 (e.g., battery, plug-in, etc.).

The interfaces 210 contain the mechanical, electrical, and signaling circuitry for communicating data over links coupled to the network(s), such as network 100. The network interfaces may be configured to transmit and/or receive data using a variety of different communication protocols. Note, further, that device 200 may have multiple types of network connections via interfaces 210, e.g., wireless and wired/physical connections, and that the view herein is merely for illustration.

Depending on the type of device, other interfaces, such as input/output (I/O) interfaces 230, user interfaces (UIs), and so on, may also be present on the device. Input devices, in particular, may include an alpha-numeric keypad (e.g., a keyboard) for inputting alpha-numeric and other information, a pointing device (e.g., a mouse, a trackball, stylus, or cursor direction keys), a touchscreen, a microphone, a camera, and so on. Additionally, output devices may include speakers, printers, particular network interfaces, monitors, etc.

The memory 240 comprises a plurality of storage locations that are addressable by the processor 220 and the interfaces 210 for storing software programs and data structures associated with the implementations described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes and/or services may comprise a wireless communication process 248, as described herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

In various implementations, as detailed further below, wireless communication process 248 may include computer executable instructions that, when executed by processor 220, cause device 200 to perform the techniques described herein. To do so, in some implementations, wireless communication process 248 may utilize artificial intelligence (AI)/machine learning (ML). In general, AI/ML is concerned with the design and the development of techniques that take as input empirical data (such as network statistics and performance indicators) and recognize complex patterns in these data. One very common pattern among these techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used very easily to classify new data points. Often, Mis a statistical model, and the cost function is inversely proportional to the likelihood of M, given the input data.

In various implementations, wireless communication process 248 may leverage one or more supervised, unsupervised, or semi-supervised AI/ML models. Generally, supervised learning entails the use of a training set of data that is used to train the model to apply labels to the input data. For example, the training data may include sample configurations labeled with textual metadata. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example AI/ML techniques that the wireless communication process 248 may employ include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, wireless communication process 248 may also include, or otherwise use, one or more generative AI/ML models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of machine unlearning, wireless communication process 248 may be a component of, use, and/or be utilized in the management of prompts/access to a generative model to perform layer attribution, perform layer sensitivity assessment, remove capabilities from a previously trained model, retain model performance, etc. based on a conversational input from a user (e.g., voice, text, etc.). Example generative approaches can include, but are not limited to, generative adversarial networks (GANs), large language models (LLMs) and other foundation models, diffusion models, transformer models, and the like.

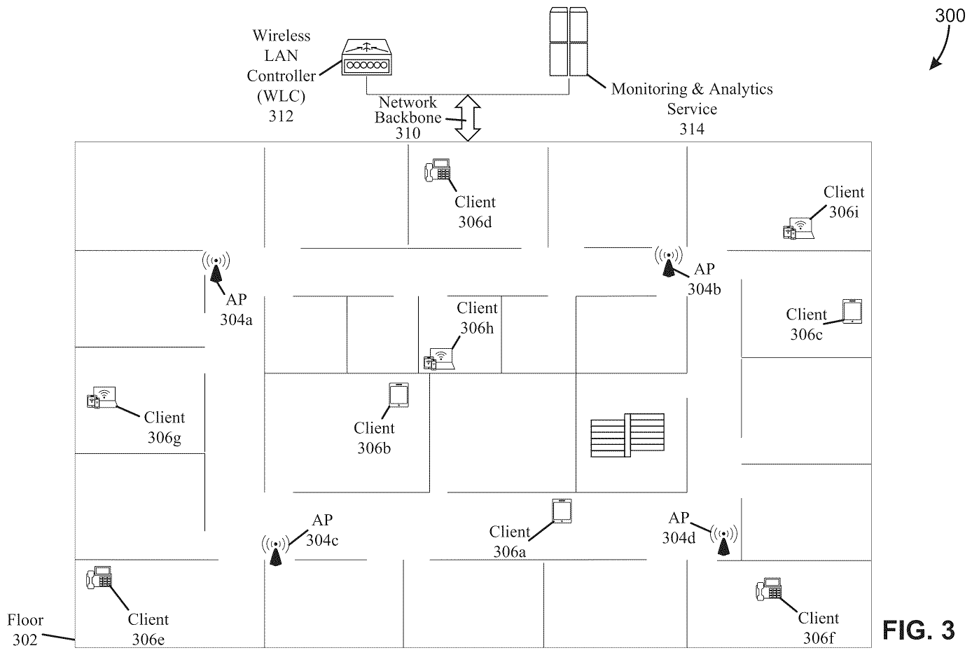

FIG. 3 illustrates an example wireless network 300, according to various embodiments. Wireless network 300 may be deployed to a physical location, such as floor 302 shown, and may include various infrastructure devices. These infrastructure devices may include, for example, one or more access points (APs) 304 that provide wireless connectivity to the various wireless clients 306 distributed throughout the location. For illustrative purposes, APs 304a-304d and clients 306a-306i are depicted in FIG. 3. However, as would be appreciated, a wireless network deployment may include any number of APs and clients.

A network backbone 310 may interconnect APs 304 and provide a connection between APs 304 and any number of supervisory devices or services that provide control over APs 304. For example, as shown, a wireless LAN controller (WLC) 312 may control some or all of APs 304a-304d, by setting their control parameters (e.g., max number of attached clients, channels used, wireless modes, etc.). Another supervisory service that oversees wireless network 300 may be a monitoring and analytics service 314 that measures and monitors the performance of wireless network 300 and, if so configured, may also adjust the operation of wireless network 300 based on the monitored performance (e.g., via WLC 312, etc.). Note that service 314 may be implemented directly on WLC 312 or may operate in conjunction therewith, in various implementations.

Network backbone 310 may further provide connectivity between the infrastructure of the local network and a larger network, such as the Internet, a Multiprotocol Label Switching (MPLS) network, or the like. Accordingly, WLC 312 and/or monitoring and analytics service 314 may be located on the same local network as APs 304 or, alternatively, may be located remotely, such as in a remote datacenter, in the cloud, etc. To provide such connectivity, network backbone 310 may include any number of wired connections (e.g., Ethernet, optical, etc.) and/or wireless connections (e.g., cellular, etc.), as well as any number of networking devices (e.g., routers, switches, etc.).

The types and configurations of clients 306 in network 300 can vary greatly, ranging from powerful computing devices to any number of different types of nodes/devices. For example, clients 306a-306i may include, but are not limited to, desktop computers, wireless sensors, actuators, thermostats, relays, mobile phones, other mobile devices, and the like.

However, as noted above, random number generation is at the core of many computing systems ranging from security to gaming, among others. For instance, in the case of cryptography, the degree of randomness underlying a cryptographic key (i.e., entropy) dictates how difficult it would be for a malicious entity to guess that key. However, random number generators (RNGs) today also do not rely on true randomness, but instead leverage pseudo-random number generation algorithms that seek to generate numbers that mimic the properties of truly random numbers.

Many of the cryptographic protocols in use today were not designed with quantum computing in mind, presenting new challenges for network security. Generally, quantum computing represents a significant shift in technology. Traditionally, computers have relied on bits that represent the binary states of their constituent transistors (i.e., a ‘1’ or a ‘0’). In contrast, quantum computers rely on quantum bits, which are referred to as “qubits,” which are two-state, quantum mechanical systems that can represent not only the traditional binary values of ‘1’ and ‘0,’ but also the superposition of the two, as well.

For instance, a quantum computer executing Shor's algorithm with enough qubits could be used to break commonly used public key cryptography protocols, such as Rivest-Shamir-Adelman (RSA), certain variations of Diffie-Hellman key exchange (e.g., elliptic curve, finite field, etc.), and the like. This creates a moving target for security experts, as the encryption protocols that network devices use to encrypt their traffic become increasingly vulnerable to advances in quantum computing.

Wireless communications, such as those within network 300, are particularly vulnerable to post-quantum threats, as they rely on a key exchange between an access point and a wireless client during their handshake operations. However, the encryption protocols in use today were not designed with quantum computing in mind. By way of example, Table 1 below illustrates some of the vulnerabilities/weaknesses present in modern Wi-Fi security protocols with respect to quantum computing:

TABLE 1

| | Quantum | |
|---|---|---|
| Standard | Vulnerability/Weakness | Why |
| WPA2/WPA3- | Client - AP Authentication | Shor's algorithm: |
| Enterprise/Personal | using public-key certificates | breaks the cipher |
| WPA2/WPA3- | Temporal Key (TK) in | Grover's algorithm: |
| Enterprise/Personal | Pairwise Transient Key | 50% easier to break |
| | (PTK): Session Key: | |
| | 128-bit | |
| WPA2/WPA3- | Hashing schemes used | Grover's algorithm |
| Enterprise/Personal | | |
| WPA2/WPA3- | Anonce, Snonce, Group | Random numbers may |
| Enterprise/Personal | Temporal Key GTK: | not be quantum- |
| | generated using | resistant nor classically |
| | pseudorandom number | secure |
| | generator (PRNG) | |

### Quantum-Resistant Wireless Communications

The techniques herein introduce a mechanism to protect wireless communications, such as those within a Wi-Fi network, from the threat of quantum computing in a holistic manner. In some aspects, a quantum-resistant key management system is introduced herein that supports the dynamic selection of the quantum-resistant algorithm to be used by the two endpoints, the path(s) via which the key material is to be conveyed, and/or the policies that the endpoints enforce.

Illustratively, the techniques described herein may be performed by hardware, software, and/or firmware, such as in accordance with wireless communication process 248, which may include computer executable instructions executed by the processor 220 (or independent processor of interfaces 210) to perform functions relating to the techniques described herein.

Specifically, according to various implementations, a key management service executed by a device determines cryptographic capabilities of a wireless client and an access point in a wireless network. The key management service selects a post-quantum cryptographic key generation approach for use by the wireless client and the access point based on their cryptographic capabilities. The key management service generates a key exchange policy for the wireless client and the access point that specifies one or more out-of-band paths that differ from a Wi-Fi link between the wireless client and the access point. The key management service causes the wireless client and the access point to perform a key exchange to associate the wireless client with the access point in the wireless network in part by generating keys using the post-quantum cryptographic key generation approach and exchanged via the one or more out-of-band paths specified by the key exchange policy.

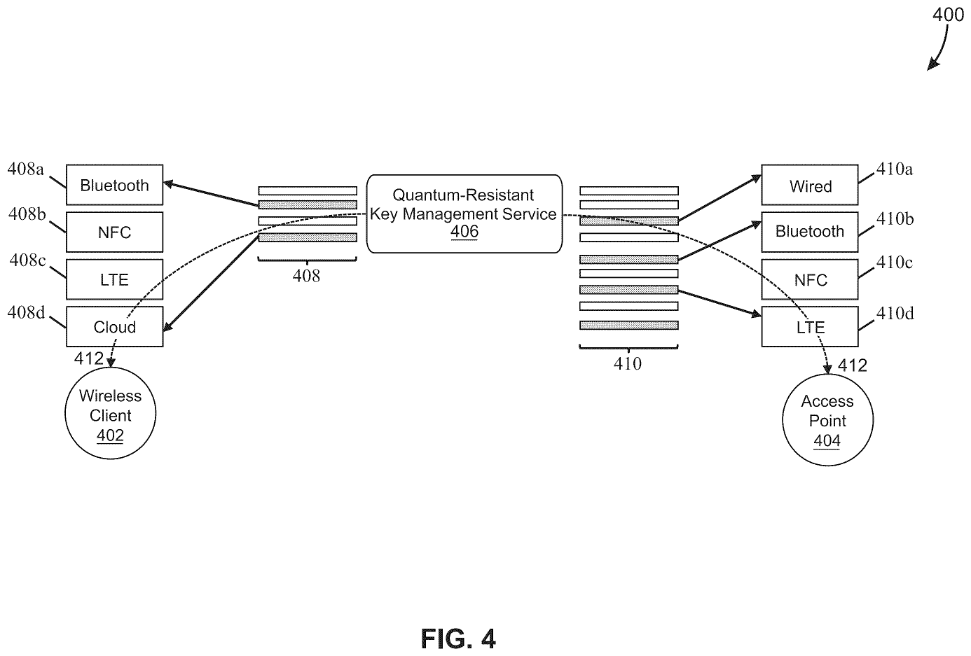

Operationally, FIG. 4 illustrates an example architecture 400 for quantum-resistant wireless communications, according to various implementations. As shown, assume that there are two endpoints that wish to communicate wirelessly with one another. By way of example, these endpoints may take the form of a wireless client 402 and access point 404, such as a client 306 and one of APs 304 described previously with respect to FIG. 3. However, in other implementations, the endpoints may take the form of other types of devices (e.g., nodes in a mesh network, cellular devices, etc.) and the techniques herein are not limited to Wi-Fi networks.

At the core of architecture 400 is quantum-resistant key management service 406 that exists between wireless client 402 and access point 404, in various implementations. For instance, quantum-resistant key management service 406 may be hosted at a WLC (e.g., 312 in FIG. 3), a server in a cloud environment or datacenter, or the like. In general, quantum-resistant key management service 406 is responsible for ensuring any or all of the following:
1. That the key generating and preparation is performed using a trusted cryptographic protocol that is quantum-resistant
2. That the key transfer is protected from post-quantum threats
3. That the sender and receiver operate in conjunction with one another to ensure receipt and recovery of the key

With respect to the key generation, quantum-resistant key management service 406 may require that the key materials used in the exchange are quantum resistant using hybrid cryptography, in some implementations. For instance, quantum-resistant key management service 406 may require the use of any or all of the following, which are combined to form the key material:
Classical cryptography: e.g., AES or another classical cryptographic algorithm
Post-quantum cryptography (PQC): e.g., Kyber (a key encapsulation mechanism that is quantum resistant) or the like.
Quantum (remote): quantum key distribution (QKD), quantum random number generation (QRNG), etc.

With respect to the exchange of key material, quantum-resistant key management service 406 may ensure that the key material is exchanged with wireless client 402 and access point 404 in a manner that ensures spatiotemporal obfuscation of the key material. Accordingly, in some implementations, quantum-resistant key management service 406 may convey the key material using any number of a variety of paths available with respect to each of wireless client 402 and access point 404. In some instances, quantum-resistant key management service 406 may also institute a key splitting mechanism whereby key information is split into different portions that are conveyed via different paths.

By way of example, assume that there are a set of paths 408 available between quantum-resistant key management service 406 and wireless client 402, such as any or all of the following paths: a Bluetooth-based path 408a, a Near-Field Communications (NFC)-based path 408b, a cellular-based path 408c, such as a Long Term Evolution (LTE)-based path, and a cloud-based path 408d. Additionally, quantum-resistant key management service 406 may also have a set of paths 410 available between it and access point 404. For instance, these paths may include a wired path 410a, a Bluetooth-based path 410b, an NFC-based path 410c, and/or a cellular-based path 410d, such as an LTE-based path.

Thus, there are multiple ways in which quantum-resistant key management service 406 may convey key information 412 to and from wireless client 402 and access point 404. To help protect against interception, quantum-resistant key management service 406 may ensure that key information 412 is sent via one or more of these paths selected randomly or, in some implementations, by taking into account the risks associated with any given path. For instance, if a particular path exhibits loss of the key information during transmission, this could indicate that the path is compromised. In such a case, quantum-resistant key management service 406 may make that path ineligible for a period of time.

Further, quantum-resistant key management service 406 may send key information 412 to quantum-resistant key management service 406 along their selected paths at different times, further obfuscating the conveyance from interception. In cases when key information 412 is split and sent via different paths, the different portions could also be sent at different times, as well.

On receipt of key information 412, the receiving endpoint may then reconstruct the key (in cases in which the key was split). In some cases, the split key may be split in such a way that the key can still be reconstructed, even if a portion of it is lost during transmission. In such cases, the receiver may be configured to discard one or more portions of the split key, such as based on the risks associated with their corresponding paths via which they were sent (e.g., by dropping the portion sent via the riskiest path). If the receiving endpoint did not receive key information 412 or a sufficient portion of its constituent parts, then it may notify quantum-resistant key management service 406 and/or the other endpoint, requesting that new key information 412 be sent.

Thus, quantum-resistant key management service 406 may facilitate the use of quantum-resistant algorithms during the 4-way handshaking involving wireless client 402 and access point 404, as well as the derivation of key materials. Further, quantum-resistant key management service 406 may ensure that quantum-resistant cryptography/PQC is used for enterprise public key infrastructure (PKI) certificate-based authentication. In turn, wireless client 402 and access point 404 may use quantum-resistant key materials that they generated/aggregated locally or received via the exchange for 4-way handshaking. In another implementation, quantum-resistant key management service 406 may facilitate installation of session keys that are exchanged using the quantum-resistant process and re-installation (renewals of keys) of quantum-resistant session keys.

Indeed, quantum-resistant key management service 406 may implement policies and mechanisms for configuration of the quantum-resistant capabilities and may also support backward compatibility of clients, access points, and other assets as part of the wireless infrastructure. In one implementation, quantum-resistant key management service 406 may also rely on a tag-based approach for key requests and exchanges, to provide its quantum resistant key management.

In one implementation, quantum-resistant key management service 406 may also include an alert and notification mechanism whereby it reports on the historical and current state of the wireless network. Such a reporting mechanism may include a user interface, one or more user-agents, and/or programmatic functions to observe and report on the users and devices with respect to their quantum-resistant security states (e.g., presence of, absence of, transition into/out of, being quantum-resistant).

A further implementation herein provides for quantum-resistant key management service 406 to facilitate the negotiation of the quantum-resistant mechanisms to be enabled, configured, or overruled between endpoints. This can be particularly helpful in the case of backwards compatibility and/or administrator authorization is in place with separation-of-duties.

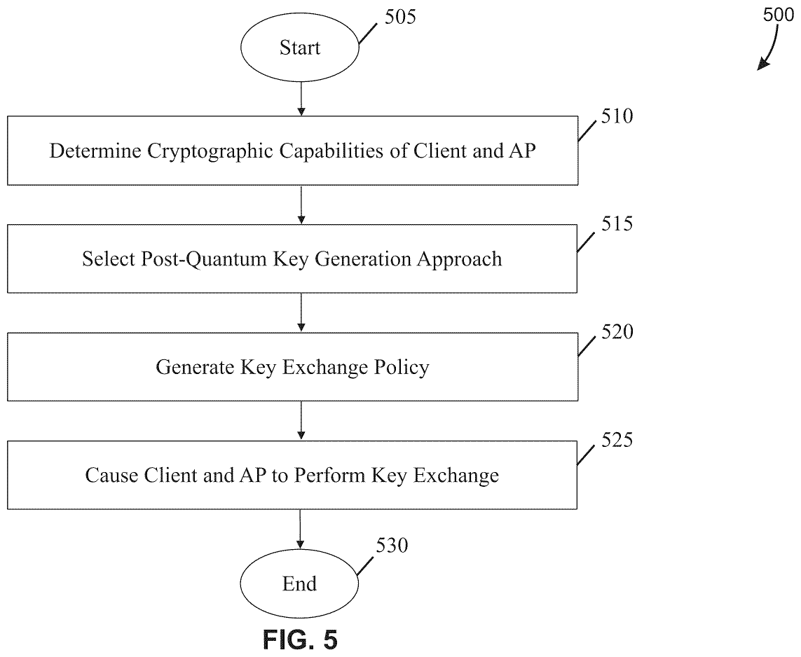

FIG. 5 illustrates an example simplified procedure 500 for establishing quantum-resistant wireless communications, in accordance with one or more implementations described herein. For example, a non-generic, specifically configured device (e.g., device 200), may perform procedure 500 (e.g., a method) by executing stored instructions (e.g., wireless communication process 248). The procedure 500 may start at step 505, and continues to step 510, where, as described in greater detail above, the device (e.g., a controller, server, etc.) may execute a key management service that determines cryptographic capabilities of a wireless client and an access point in a wireless network.

At step 515, as detailed above, the key management service selects a post-quantum cryptographic key generation approach for use by the wireless client and the access point based on their cryptographic capabilities. In one implementation, the post-quantum cryptographic key generation approach uses a quantum random number generator (QRNG) to generate key materials. In another implementation, the post-quantum cryptographic key generation approach uses a hybrid cryptographic approach that combines keys generated using post-quantum cryptography with at least one of: classical cryptography or quantum-based cryptography.

At step 520, the key management service generates a key exchange policy for the wireless client and the access point that specifies one or more out-of-band paths that differ from a Wi-Fi link between the wireless client and the access point, as described in greater detail above. In one implementation, the one or more out-of-band paths comprise a Bluetooth link between the wireless client and the access point. In a further implementation, the one or more out-of-band paths comprise a cellular connection between the wireless client and the access point. In yet another implementation, the one or more out-of-band paths comprise a Near Field Communication (NFC) link between the wireless client and the access point.

At step 525, as detailed above, the key management service causes the wireless client and the access point to perform a key exchange to associate the wireless client with the access point in the wireless network in part by generating keys using the post-quantum cryptographic key generation approach and exchanged via the one or more out-of-band paths specified by the key exchange policy. In various implementations, the key exchange policy causes the wireless client and the access point to split their keys into portions and send those portions via different out-of-band paths. In one implementation, the key exchange policy also causes the wireless client and the access point to send the portions at different times. In some implementations, the device may also provide, to a user interface, an indication that the wireless client and the access point are in a quantum-resistant security state. In one implementation, the wireless client and the access point perform the key exchange as part of a handshake to associate the wireless client with the access point.

Procedure 500 may then end at step 530.

It should be noted that while certain steps within procedure 500 may be optional as described above, the steps shown in FIG. 5 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

While there have been shown and described illustrative implementations that provide for quantum-resistant wireless communications, it is to be understood that various other adaptations and modifications may be made within the intent and scope of the implementations herein. In addition, while certain processes are shown, other suitable processes may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

1. A method, comprising:
determining, by a key management service executed by a device, cryptographic capabilities of a wireless client and an access point in a wireless network;
selecting, by the key management service, a post-quantum cryptographic key generation approach for use by the wireless client and the access point based on their cryptographic capabilities;
generating, by the key management service, a key exchange policy for the wireless client and the access point that specifies one or more out-of-band paths that differ from a Wi-Fi link between the wireless client and the access point; and
causing, by the key management service, the wireless client and the access point to perform a key exchange to associate the wireless client with the access point in the wireless network in part by generating keys using the post-quantum cryptographic key generation approach and exchanged via the one or more out-of-band paths specified by the key exchange policy.

2. The method as in claim 1, wherein the one or more out-of-band paths comprise a Bluetooth link between the wireless client and the access point.

3. The method as in claim 1, wherein the one or more out-of-band paths comprise a cellular connection between the wireless client and the access point.

4. The method as in claim 1, wherein the one or more out-of-band paths comprise a Near Field Communication (NFC) link between the wireless client and the access point.

5. The method as in claim 1, wherein the key exchange policy causes the wireless client and the access point to split their keys into portions and send those portions via different out-of-band paths.

6. The method as in claim 5, wherein the key exchange policy causes the wireless client and the access point to send the portions at different times.

7. The method as in claim 1, wherein the post-quantum cryptographic key generation approach uses a quantum random number generator (QRNG) to generate key materials.

8. The method as in claim 1, further comprising:
providing, to a user interface, an indication that the wireless client and the access point are in a quantum-resistant security state.

9. The method as in claim 1, wherein the post-quantum cryptographic key generation approach uses a hybrid cryptographic approach that combines keys generated using post-quantum cryptography with at least one of: classical cryptography or quantum-based cryptography.

10. The method as in claim 1, wherein the wireless client and the access point perform the key exchange as part of a handshake to associate the wireless client with the access point.

11. An apparatus, comprising:
one or more network interfaces;
a processor coupled to the one or more network interfaces and configured to execute one or more processes; and
a memory configured to store a process that is executable by the processor, the process when executed configured to:
determine, by a key management service executed by the apparatus, cryptographic capabilities of a wireless client and an access point in a wireless network;
select, by the key management service, a post-quantum cryptographic key generation approach for use by the wireless client and the access point based on their cryptographic capabilities;
generate, by the key management service, a key exchange policy for the wireless client and the access point that specifies one or more out-of-band paths that differ from a Wi-Fi link between the wireless client and the access point; and
cause, by the key management service, the wireless client and the access point to perform a key exchange to associate the wireless client with the access point in the wireless network in part by generating keys using the post-quantum cryptographic key generation approach and exchanged via the one or more out-of-band paths specified by the key exchange policy.

12. The apparatus as in claim 11, wherein the one or more out-of-band paths comprise a Bluetooth link between the wireless client and the access point.

13. The apparatus as in claim 11, wherein the one or more out-of-band paths comprise a cellular connection between the wireless client and the access point.

14. The apparatus as in claim 11, wherein the one or more out-of-band paths comprise a Near Field Communication (NFC) link between the wireless client and the access point.

15. The apparatus as in claim 11, wherein the key exchange policy causes the wireless client and the access point to split their keys into portions and send those portions via different out-of-band paths.

16. The apparatus as in claim 15, wherein the key exchange policy causes the wireless client and the access point to send the portions at different times.

17. The apparatus as in claim 11, wherein the post-quantum cryptographic key generation approach uses a quantum random number generator (QRNG) to generate key materials.

18. The apparatus as in claim 11, wherein the process when executed is further configured to:
provide, to a user interface, an indication that the wireless client and the access point are in a quantum-resistant security state.

19. The apparatus as in claim 11, wherein the post-quantum cryptographic key generation approach uses a hybrid cryptographic approach that combines keys generated using post-quantum cryptography with at least one of: classical cryptography or quantum-based cryptography.

20. A tangible, non-transitory, computer-readable medium storing program instructions that cause a device to execute a process comprising:
determining, by a key management service executed by the device, cryptographic capabilities of a wireless client and an access point in a wireless network;
selecting, by the key management service, a post-quantum cryptographic key generation approach for use by the wireless client and the access point based on their cryptographic capabilities;
generating, by the key management service, a key exchange policy for the wireless client and the access point that specifies one or more out-of-band paths that differ from a Wi-Fi link between the wireless client and the access point; and
causing, by the key management service, the wireless client and the access point to perform a key exchange to associate the wireless client with the access point in the wireless network in part by generating keys using the post-quantum cryptographic key generation approach and exchanged via the one or more out-of-band paths specified by the key exchange policy.
